(19) United States
(12) Patent Application Publication
(10) Pub. No.: US 2023/0068025 A1
(43) Pub. Date: Mar. 2, 2023

(54) METHOD AND APPARATUS FOR GENERATING ROAD ANNOTATION, DEVICE AND STORAGE MEDIUM

(71) Applicant: Beijing Baidu Netcom Science Technology Co., Ltd., Beijing (CN)

(72) Inventors: Yan PENG, Beijing (CN); Xiang LONG, Beijing (CN); Honghui ZHENG, Beijing (CN); Zhuang JIA, Beijing (CN); Bin ZHANG, Beijing (CN); Xiaodi WANG, Beijing (CN); Ying XIN, Beijing (CN); Yi GU, Beijing (CN); Yunhao WANG, Beijing (CN); Chao LI, Beijing (CN); Yuan FENG, Beijing (CN); Shumin HAN, Beijing (CN)

(21) Appl. No.: 17/981,965

(22) Filed: Nov. 7, 2022

Related U.S. Application Data
(63) Continuation of application No. PCT/CN2022/075068, filed on Jan. 29, 2022.

(30) Foreign Application Priority Data
Jun. 2, 2021 (CN) 202110611771.4

(51) Int. Cl. G06V 20/10; G06V 10/46

(52) U.S. Cl. CPC G06V 20/182; G06V 10/46

(57) ABSTRACT

A method for generating a road annotation, a device, and a storage medium are provided. The method may include: generating a road quantity and a road width in a tag picture; generating, for each road in the tag picture, a start point and an end point of the road; generating at least one point between the start point and the end point; drawing, for two adjacent points, a line segment from a previous point to a next point, where a width of the line segment is equal to the road width; and generating slanted box annotation information based on a coordinate of the previous point and a coordinate of the next point, where the slanted box annotation information includes an intersection point of diagonal lines, a width, a height and a slant angle of a slanted box.

### CROSS-REFERENCE TO RELATED APPLICATION

This patent application is a continuation of International Application No. PCT/CN2022/075068, filed on Jan. 29, 2022, which claims the priority from Chinese Patent Application No. 202110611771.4, filed on Jun. 2, 2021 and titled “Method and Apparatus for Generating Road Annotation, Device and Storage Medium”. The content of these applications are incorporated herein by reference in their entireties.

### TECHNICAL FIELD

The present disclosure relates to the field of artificial intelligence, and specifically to computer vision and deep learning technologies, and may be applied to scenarios of remote sensing images.

### BACKGROUND

Road extraction of remote sensing images aims to perform a pixel-level content analysis on remote sensing images to extract road information in the images, which has a very high practical value in fields such as the field of urban and rural planning and the field of mapmaking. However, training a model used to extract road information of the remote sensing images requires a large number of remote sensing images annotated with slanted box annotation information.

### SUMMARY

Embodiments of the present disclosure propose a method for generating a road annotation, a device, and a storage medium.

In a first aspect, a method for generating a road annotation is provide, which includes: generating a road quantity and a road width in a tag picture; generating, for each road in the tag picture, a start point and an end point of the road; generating at least one point between the start point and the end point; drawing, for two adjacent points, a line segment from a previous point to a next point, where a width of the line segment is equal to the road width; and generating slanted box annotation information based on a coordinate of the previous point and a coordinate of the next point, where the slanted box annotation information includes an intersection point of diagonal lines, a width, a height and a slant angle of a slanted box.

In a second aspect, an electronic device is provided, which includes: at least one processor; and a storage device, in communication with the at least one processor, where the storage device stores instructions executable by the at least one processor, and the instructions are executed by the at least one processor, to enable the at least one processor to perform the method according to any one of embodiments of the first aspect.

In a third aspect, a non-transitory computer readable storage medium, storing a computer instruction according to embodiments of the disclosure is provide, where the computer instruction is used to cause a computer to perform the method according any one of embodiment of the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

Through the detailed descriptions of non-limiting embodiments given with reference to the following accompanying drawings, other features, objectives and advantages of the present disclosure will be more apparent. The accompanying drawings are used for a better understanding of the scheme, and do not constitute a limitation to the present disclosure. Here:

FIG. 1 is a flowchart of an embodiment of a method for generating a road annotation according to the present disclosure;

FIG. 2 is a flowchart of another embodiment of the method for generating a road annotation according to the present disclosure;

FIG. 3 is a schematic structural diagram of an embodiment of an apparatus for generating a road annotation according to the present disclosure; and

FIG. 4 is a block diagram of an electronic device adapted to implement the method for generating a road annotation according to the embodiments of the present disclosure.

### DETAILED DESCRIPTION OF EMBODIMENTS

Example embodiments of the present disclosure are described below in combination with the accompanying drawings, and various details of the embodiments of the present disclosure are included in the description to facilitate understanding, and should be considered as examples only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

It should be noted that the embodiments in the present disclosure and the features in the embodiments may be combined with each other on a non-conflict basis. The present disclosure will be described below in detail with reference to the accompanying drawings and in combination with the embodiments.

In the related art, a large number of remote sensing images are generally acquired, and a slanted box annotation is performed on the remote sensing images.

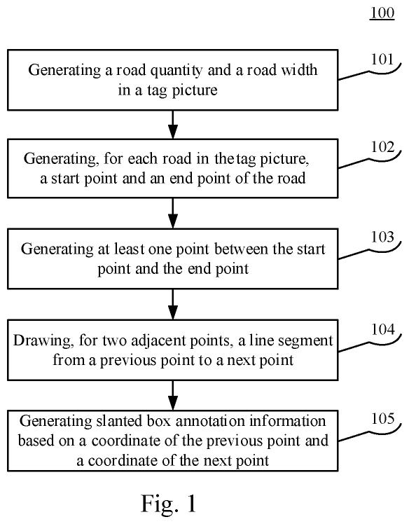

FIG. 1 illustrates a flow 100 of an embodiment of a method for generating a road annotation according to the present disclosure. The method for generating a road annotation includes the following steps.

Step 101 includes generating a road quantity and a road width in a tag picture.

In this embodiment, an executing body of the method for generating a road annotation may generate the road quantity and the road width in the tag picture.

In practice, training a model used to extract road information of a remote sensing image requires a large number of remote sensing images annotated with slanted box annotation information. In order to improve the efficiency, the slanted box annotation information of roads of a large number of fictitious remote sensing images may be generated. The tag picture may be a blank picture. By generating a road and slanted box annotation information on the tag picture, a fictitious remote sensing image and corresponding slanted box annotation information may be obtained. The size of a tag picture, the number of tag pictures, and the road quantity and the road width in each tag picture may be specified according to actual scenario demands. For example, the size of the tag picture is specified as 1024*1024, the number of the tag pictures is specified as 100, the road quantity in each tag picture is specified as 5, the road width of each tag picture is specified as 4 meters. It should be noted that the road quantity and the road width in each tag picture may be adjusted according to specific demands. For example, when a rural road is simulated, the range of the road quantity in each tag picture may be [1, 5], and the range of the road width in each tag picture may be [1, 5]. When an urban road is simulated, the range of the road quantity in each tag picture may be [3, 10], and the range of the road width in each tag picture may be [3, 20].

Step 102 includes generating, for each road in the tag picture, a start point and an end point of the road.

In this embodiment, for each road in the tag picture, the above executing body may generate the start point and the end point of the road.

In practice, the start point of the road may be any pixel point in the tag picture, but the end point of the road must be on the four boundaries of the tag picture. The width of each road is constant from the start point to the end point. Different roads are allowed to intersect with each other. Taking a tag picture of a size of 1024*1024 as an example, a coordinate system takes the vertex of the upper left corner of the tag picture as an origin, the upper boundary of the tag picture as an x-axis of which the rightward direction is the positive direction of the x-axis, and the left boundary of the tag picture as a y-axis of which the downward direction is the positive direction of the y-axis. The coordinate of the generated start point of the road is (x0, y0), and the coordinate of the end point of the road is (tx, ty). Here, x0, y0, tx and ty are all integers. The range of each of x0 and y0 is [0, 1023]. When the end point of the road is on the upper boundary of the tag picture, the range of tx is [0, 1023], and ty=0. When the end point of the road is on the right boundary of the tag picture, tx=1023, and the range of ty is [0, 1023]. When the end point of the road is on the lower boundary of the tag picture, the range of tx is [0, 1023], and ty=1023. When the end point of the road is on the left boundary of the tag picture, tx=0, and the range of ty is [0, 1023].

Step 103 includes generating at least one point between the start point and the end point.

In this embodiment, the above executing body may generate the at least one point between the start point and the end point of the road. Here, the number of points generated between the start point and the end point of the road may be random or preset. The distance between points may be random or preset. The number and the distance are not specifically limited here.

Step 104 includes drawing, for two adjacent points, a line segment from a previous point to a next point.

In this embodiment, for the two adjacent points, the above executing body may draw the line segment from the previous point to the next point. Here, the width of the line segment is equal to the road width. Accordingly, the road on the tag picture is formed by connecting a plurality of line segments end to end between the start point and the end point, which makes the road more standardized and have a better continuity.

Step 105 includes generating slanted box annotation information based on a coordinate of the previous point and a coordinate of the next point.

In this embodiment, the above executing body may generate the slanted box annotation information based on the coordinates of the previous point and the next point. Here, a slanted box may be line segments connecting the previous points and the next points. The slanted box annotation information may include the intersection point of diagonal lines, a width, a height and a slant angle of the slanted box.

In some alternative implementations of this embodiment, the coordinate of the previous point is (x1, y1), the coordinate of the next point is (x2, y2), and the road width is width. The slanted box annotation information is specifically as follows.

The abscissa cx of the intersection point of the diagonal lines of the slanted box satisfies cx=(x1+x2)/2, and the ordinate cy of the intersection point of the diagonal lines of the slanted box satisfies cy=(y1+y2)/2.

The width w of the slanted box satisfies w=\sqrt{(x2−x1)²+(y2−y1)²}.

The height h of the slanted box is equal to the width.

The slant angle theta of the slanted box satisfies theta=arctan 2[(y2−y1),(x2−x1)]. Here, when

$$theta > \frac{3}{4} π ,$$

the slant angle theta of the slanted box satisfies theta=theta−π, and when

$$theta < - \frac{1}{4} π ,$$

the slant angle theta of the slanted box satisfies theta=theta+π. In this way, the value of the slant angle theta of the slanted box is limited between

$$- \frac{1}{4} π and \frac{3}{4} π .$$

In some alternative implementations of this embodiment, the tag picture annotated with the slanted box annotation information may be used as a training sample to perform supervised training on a slanted box annotation model. The trained slanted box annotation model may be used to perform a slanted box annotation on the remote sensing image, to further extract the road in the remote sensing image, which makes the extracted road more standardized and have a better continuity.

According to the method for generating a road annotation provided in the embodiment of the present disclosure, the size of the picture, the number of pictures, and the road quantity and the road width in each picture are specified, and the slanted box annotation information of the road in the fictitious remote sensing image is generated, to provide auxiliary data for the slanted box detection on the road. The slanted box annotation information of the road can be obtained while the fictitious remote sensing image is generated, thereby improving the efficiency of generating the auxiliary data. Moreover, the road in the fictitious remote sensing image is formed by connecting a plurality of line segments end to end, which makes the road more standardized and have a better continuity.

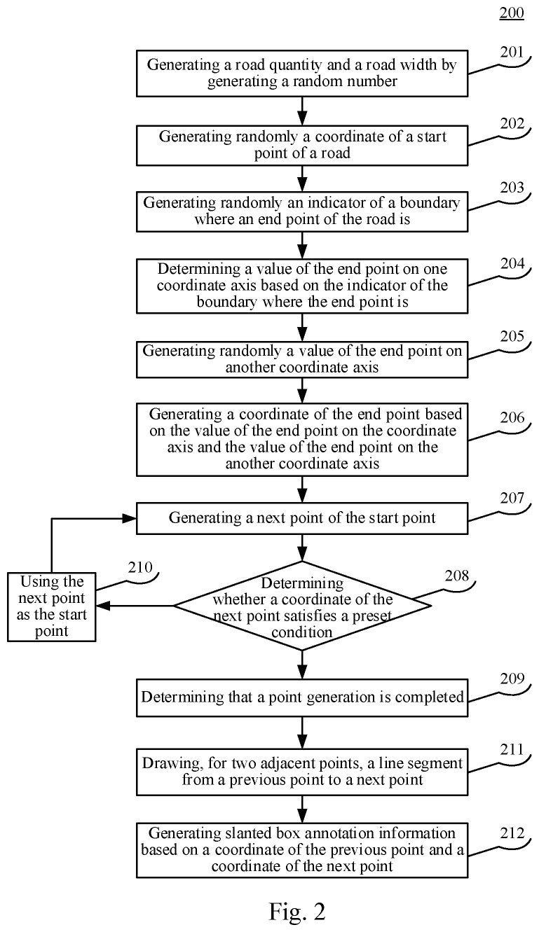

Further referring to FIG. 2, FIG. 2 illustrates a flow 200 of another embodiment of the method for generating a road annotation according to the present disclosure. The method for generating a road annotation includes the following steps.

Step 201 includes generating a road quantity and a road width by generating a random number.

In this embodiment, an executing body of the method for generating a road annotation may generate the road quantity and the road width by generating the random number, which makes a generated fictitious remote sensing image more diversified.

Step 202 includes generating randomly, for each road in a tag picture, a coordinate of a start point of the road.

In this embodiment, for each road in the tag picture, the above executing body may randomly generate the coordinate of the start point of the road, which makes the road more diversified.

Taking a tag picture of a size of 1024*1024 as an example, a coordinate system takes the vertex of the upper left corner of the tag picture as an origin, the upper boundary of the tag picture as an x-axis of which the rightward direction is the positive direction of the x-axis, and the left boundary of the tag picture as a y-axis of which the downward direction is the positive direction of the y-axis. The generated coordinate of the start point of the road is (x0, y0). Here, x0 and y0 are both integers. Each of the ranges of x0 and y0 is [0, 1023].

Step 203 includes generating randomly an indicator of a boundary where an end point of the road is.

In this embodiment, the above executing body may randomly generate the indicator of the boundary where the end point of the road is, which makes the road more diversified.

Here, the end point is on the boundary of the tag picture. The indicator may be used to indicate the specific boundary where the end point is. For example, when the indicator e is equal to 1, the indicator indicates that the end point of the road is on the upper boundary of the tag picture. When the indicator e is equal to 2, the indicator indicates that the end point of the road is on the right boundary of the tag picture. When the indicator e is equal to 3, the indicator indicates that the end point of the road is on the lower boundary of the tag picture. When the indicator e is equal to 4, the indicator indicates that the end point of the road is on the left boundary of the tag picture.

Step 204 includes determining a value of the end point on one coordinate axis based on the indicator of the boundary where the end point is.

In this embodiment, the above executing body may determine the value of the end point on the coordinate axis based on the indicator of the boundary where the end point is.

Taking a tag picture of a size of 1024*1024 as an example, a coordinate system takes the vertex of the upper left corner of the tag picture as an origin, the upper boundary of the tag picture as an x-axis of which the rightward direction is the positive direction of the x-axis, and the left boundary of the tag picture as a y-axis of which the downward direction is the positive direction of the y-axis. When the indicator e is equal to 1, the indicator indicates that the end point of the road is on the upper boundary of the tag picture, and thus, it can be determined that the ordinate ty of the end point is equal to 0. When the indicator e is equal to 2, the indicator indicates that the end point of the road is on the right boundary of the tag picture, and thus, it may be determined that the abscissa tx of the end point is equal to 1023. When the indicator e is equal to 3, the indicator indicates that the end point of the road is on the lower boundary of the tag picture, and thus, it may be determined that the ordinate ty of the end point is equal to 1023. When the indicator e is equal to 4, the indicator indicates that the end point of the road is on the left boundary of the tag picture, and thus, it may be determined that the abscissa tx of the end point is equal to 0.

Step 205 includes generating randomly a value of the end point on another coordinate axis.

In this embodiment, the above executing body may randomly generate the value of the end point on another coordinate axis, which makes the road more diversified.

Taking a tag picture of a size of 1024*1024 as an example, a coordinate system takes the vertex of the upper left corner of the tag picture as an origin, the upper boundary of the tag picture as an x-axis of which the rightward direction is the positive direction of the x-axis, and the left boundary of the tag picture as a y-axis of which the downward direction is the positive direction of the y-axis. When the indicator e is equal to 1, the indicator indicates that the end point of the road is on the upper boundary of the tag picture, and thus, it may be determined that the ordinate ty of the end point is equal to 0 and the range of the abscissa tx of the end point is [0, 1023]. When the indicator e is equal to 2, the indicator indicates that the end point of the road is on the right boundary of the tag picture, and thus, it may be determined that the abscissa tx of the end point is equal to 1023 and the range of the ordinate ty of the end point is [0, 1023]. When the indicator e is equal to 3, the indicator indicates that the end point of the road is on the lower boundary of the tag picture, and thus, it may be determined that the ordinate ty of the end point is equal to 1023 and the range of the abscissa tx of the end point is [0, 1023]. When the indicator e is equal to 4, the indicator indicates that the end point of the road is on the left boundary of the tag picture, and thus, it may be determined that the abscissa tx of the end point is equal to 0 and the range of the ordinate ty of the end point is [0, 1023].

Step 206 includes generating a coordinate of the end point based on the value of the end point on one coordinate axis and the value of the end point on another coordinate axis.

In this embodiment, the above executing body may generate the coordinate of the end point based on the value of the end point on the one coordinate axis and the value of the end point on the another coordinate axis.

Taking a tag picture of a size of 1024*1024 as an example, a coordinate system takes the vertex of the upper left corner of the tag picture as an origin, the upper boundary of the tag picture as an x-axis of which the rightward direction is the positive direction of the x-axis, and the left boundary of the tag picture as a y-axis of which the downward direction is the positive direction of the y-axis. When the indicator e is equal to 1, the indicator indicates that the end point of the road is on the upper boundary of the tag picture, and thus, it may be determined that the ordinate ty of the end point is equal to 0 and the value range of the abscissa tx of the end point is [0, 1023], that is, the coordinate of the end point is (tx, 0). When the indicator e is equal to 2, the indicator indicates that the end point of the road is on the right boundary of the tag picture, and thus, it may be determined that the abscissa tx of the end point is equal to 1023 and the range of the ordinate ty of the end point is [0, 1023], that is, the coordinate of the end point are (1023, ty). When the indicator e is equal to 3, the indicator indicates that the end point of the road is on the lower boundary of the tag picture, and thus, it may be determined that the ordinate of the end point is ty=1023 and the range of the abscissa tx of the end point is [0, 1023], that is, the coordinate of the end point is (tx, 1023). When the indicator e is equal to 4, the indicator indicates that the end point of the road is on the left boundary of the tag picture, and thus, it may be determined that the abscissa tx of the end point is equal to 0 and the range of the ordinate ty of the end point is [0, 1023], that is, the coordinate of the end point is (0, ty).

Step 207 includes generating a next point of the start point.

In this embodiment, the above executing body may generate the next point of the start point.

Generally, a random number between the abscissa of the start point and the abscissa of the end point may be taken as the abscissa of the next point, and a random number between the ordinate of the start point and the ordinate of the end point may be taken as the ordinate of the next point, such that the next point does not exceed the range defined by the start point and the end point, which makes the generated road more in line with actual situations, thereby avoiding a road oscillation.

Step 208 includes determining whether a coordinate of the next point satisfy a preset condition.

In this embodiment, the above executing body may determine whether the coordinate of the next point satisfies the preset condition. If the coordinate satisfy the preset condition, step 209 is performed. If the coordinate does not satisfy the preset condition, step 210 is performed.

Here, the preset condition may be various conditions set in advance. For example, the preset condition may include the abscissa of the next point being identical to the abscissa of the end point and/or the ordinate of the next point being identical to the ordinate of the end point, thereby avoiding a road oscillation.

Step 209 includes determining that a point generation is completed.

In this embodiment, if the coordinate of the next point satisfies the preset condition, it is determined that the point generation is completed, and step 211 is then performed.

Step 210 includes using the next point as the start point.

In this embodiment, if the coordinate of the next point does not satisfy the preset condition, the above executing body may use the next point as the start point, and continue to perform the point generation step 207. The next point is generated for the road until the preset condition is satisfied, such that the road is started from the start point and advances gradually toward the end point, which makes the generated road more in line with actual situations.

Step 211 includes drawing, for two adjacent points, a line segment from a previous point to a next point.

Step 212 includes generating slanted box annotation information based on the coordinate of the previous point and the coordinate of the next point.

In this embodiment, the detailed operations of steps 211-212 have been described in steps 104-105 in the embodiment shown in FIG. 1, and thus will not be repeatedly described here.

It can be seen from FIG. 2 that, as compared with the embodiment corresponding to FIG. 1, the method for generating a road annotation in this embodiment emphasizes the step of randomly generating the road and the point generation step. Thus, according to the scheme described in this embodiment, the road quantity, the road width, the start point and the end point are randomly generated, which makes the road more diversified. The next point is generated for the road until the preset condition is satisfied, such that the road is started from the start point and advances gradually toward the end point, which makes the generated road more in line with actual situations.

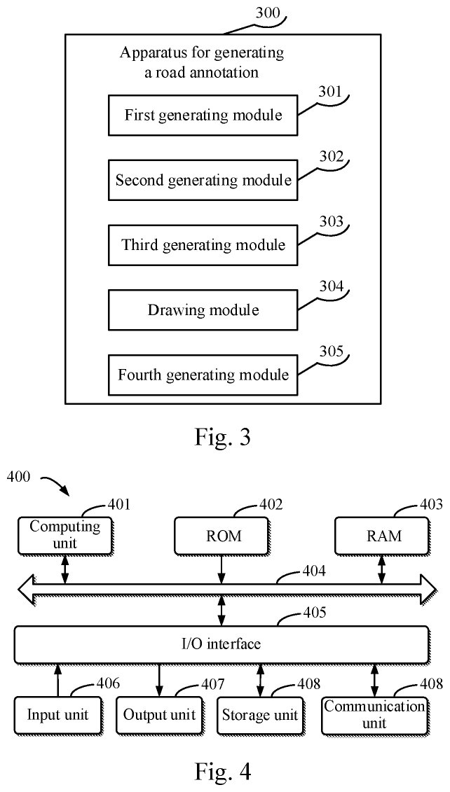

Further referring to FIG. 3, as an implementation of the method shown in the above drawings, the present disclosure provides an embodiment of an apparatus for generating a road annotation. The embodiment of the apparatus corresponds to the embodiment of the method shown in FIG. 1, and the apparatus may be applied in various electronic devices.

As shown in FIG. 3, the apparatus 300 for generating a road annotation in this embodiment may include: a first generating module 301, a second generating module 302, a third generating module 303, a drawing module 304 and a fourth generating module 305. Here, the first generating module 301 is configured to generate a road quantity and a road width in a tag picture. The second generating module 302 is configured to generate, for each road in the tag picture, a start point and an end point of the road. The third generating module 303 is configured to generate at least one point between the start point and the end point. The drawing module 304 is configured to draw, for two adjacent points, a line segment from a previous point to a next point. Here, a width of the line segment is equal to the road width. The fourth generating module 305 is configured to generate slanted box annotation information based on a coordinate of the previous point and a coordinate of the next point. Here, the slanted box annotation information includes an intersection point of diagonal lines, a width, a height and a slant angle of a slanted box.

In this embodiment, for specific processes of the first generating module 301, the second generating module 302, the third generating module 303, the drawing module 304 and the fourth generating module 305 in the apparatus 300 for generating a road annotation, and their technical effects, reference may be respectively made to the related descriptions of steps 101-105 in the corresponding embodiment of FIG. 1, and thus, the details will not be repeatedly described here.

In some alternative implementations of this embodiment, the third generating module 303 is further configured to: perform following point generation steps: generating a next point of the start point and determining whether a coordinate of the next point satisfies a preset condition; determining that a point generation is completed in response to the coordinate satisfying the preset condition; and using the next point as the start point and continuing to perform the point generation steps, in response to the coordinate not satisfying the preset condition.

In some alternative implementations of this embodiment, a random number between an abscissa of the start point and an abscissa of the end point is taken as an abscissa of the next point, a random number between an ordinate of the start point and an ordinate of the end point is taken as an ordinate of the next point, and the preset condition includes the abscissa of the next point being identical to the abscissa of the end point and/or the ordinate of the next point being identical to the ordinate of the end point.

In some alternative implementations of this embodiment, the coordinate of the previous point is (x1, y1), the coordinate of the next point is (x2, y2), the road width is width, an abscissa of the intersection point of the diagonal lines of the slanted box is cx=(x1+x2)/2, an ordinate cy of the intersection point of the diagonal lines of the slanted box satisfies cy=(y1+y2)/2, the width w of the slanted box satisfies w=\sqrt{(x2−x1)²+(y2−y1)²}, the height h of the slanted box satisfies h=width, and the slant angle theta of the slanted box satisfies theta=arctan 2[(y2−y1),(x2−x1)]. Here, when

$$theta > \frac{3}{4} π ,$$

the slant angle theta of the slanted box satisfies theta=theta−π, and when

$$theta < - \frac{1}{4} π ,$$

the slant angle of the slanted box satisfies theta=theta+π.

In some alternative implementations of this embodiment, the second generating module 302 is further configured to: generate randomly a coordinate of the start point of the road; generate randomly an indicator of a boundary where the end point of the road is, where the end point is on a boundary of the tag picture; determine a value of the end point on one coordinate axis based on the indicator of the boundary where the end point is; generate randomly a value of the end point on another coordinate axis; and generate a coordinate of the end point based on the value of the end point on the one coordinate axis and the value of the end point on the another coordinate axis.

In some alternative implementations of this embodiment, the first generating module 301 is configured to: generate the road quantity and the road width by generating a random number.

In the technical solution of the present disclosure, the acquisition, storage, application, etc. of the personal information of a user all comply with the provisions of the relevant laws and regulations, and do not violate public order and good customs.

According to an embodiment of the present disclosure, the present disclosure further provides an electronic device, a readable storage medium, and a computer program product.

FIG. 4 is a schematic block diagram of an example electronic device 400 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 4, the device 400 includes a computing unit 401, which can perform various appropriate actions and processes according to a computer program stored in a read only memory (ROM) 402 or a computer program loaded from the storage unit 408 into a random access memory (RAM) 403. In RAM 403, various programs and data required for the operation of device 400 can also be stored. The computing unit 401, ROM 402, and RAM 403 are connected to each other through a bus 404. Input/output (I/O) interface 405 is also connected to bus 404.

A plurality of components in the device 400 are connected to the I/O interface 405, including: an input unit 406, such as a keyboard, a mouse, etc.; an output unit 407, such as various types of displays, speakers, and the like; a storage unit 408, such as a magnetic disk, an optical disk, and the like; and a communication unit 409, such as a network card, a modem, a wireless communication transceiver, and the like. The communication unit 409 allows the device 400 to exchange information/data with other devices through computer networks such as the Internet and/or various telecommunication networks.

The computing unit 401 may be various general-purpose and/or special-purpose processing components with processing and computing capabilities. Some examples of the computing unit 401 include, but are not limited to, a central processing unit (CPU), a graphics processing unit (GPU), various dedicated artificial intelligence (AI) computing chips, various computing units that run machine learning model algorithms, digital signal processors (DSPS), and any appropriate processors, controllers, microcontrollers, and the like. The calculation unit 401 performs the various methods and processes described above, such as a method for training a video recognition model. For example, in some embodiments, the method for training a video recognition model may be implemented as a computer software program that is tangibly contained in a machine-readable medium, such as a storage unit 408. In some embodiments, part or all of the computer program may be loaded and/or installed on the device 400 via ROM 402 and/or communication unit 409. When the computer program is loaded into RAM 403 and executed by the computing unit 401, one or more steps of the method for training a video recognition model described above may be performed. Alternatively, in other embodiments, the computing unit 401 may be configured to perform the method for training a video recognition model by any other suitable means (e.g., by means of firmware).

Various embodiments of the systems and technologies described above in this paper can be implemented in digital electronic circuit systems, integrated circuit systems, field programmable gate arrays (FPGAs), application specific integrated circuits (ASIC), application specific standard products (ASSP), system on chip (SOC), load programmable logic devices (CPLD), computer hardware, firmware, software, and/or combinations thereof. These various embodiments may include: being implemented in one or more computer programs, the one or more computer programs can be executed and/or interpreted on a programmable system including at least one programmable processor, which can be a special-purpose or general-purpose programmable processor, and can receive data and instructions from the storage system, at least one input device, and at least one output device, and transmitting data and instructions to the storage system, the at least one input device, and the at least one output device.

The program code for implementing the methods of the present disclosure may be written in any combination of one or more programming languages. These program codes can be provided to the processor or controller of general-purpose computer, special-purpose computer or other programmable data processing device, so that when the program code is executed by the processor or controller, the functions/operations specified in the flow chart and/or block diagram are implemented. The program code can be completely executed on the machine, partially executed on the machine, partially executed on the machine and partially executed on the remote machine as a separate software package, or completely executed on the remote machine or server.

In the context of the present disclosure, a machine-readable medium may be a tangible medium that may contain or store a program for use by or in combination with an instruction execution system, apparatus, or device. The machine-readable medium can be a machine-readable signal medium or a machine-readable storage medium. Machine readable media may include, but are not limited to, electronic, magnetic, optical, electromagnetic, infrared, or semiconductor systems, apparatuses, or devices, or any suitable combination of the foregoing. More specific examples of machine-readable storage media may include one or more wire based electrical connections, portable computer disks, hard disks, random access memory (RAM), read only memory (ROM), erasable programmable read only memory (EPROM or flash memory), optical fibers, compact disk read only memory (CD-ROM), optical storage devices, magnetic storage devices, or any suitable combination of the above.

In order to provide interaction with users, the systems and techniques described herein can be implemented on a computer with: a display device for displaying information to users (for example, a CRT (cathode ray tube) or LCD (liquid crystal display) monitor); and a keyboard and a pointing device (e.g., a mouse or a trackball) through which the user can provide input to the computer. Other kinds of devices can also be used to provide interaction with users. For example, the feedback provided to the user may be any form of sensor feedback (e.g., visual feedback, auditory feedback, or tactile feedback); and the input from the user can be received in any form (including acoustic input, voice input or tactile input).

The systems and techniques described herein may be implemented in a computing system including background components (e.g., as a data server), or a computing system including middleware components (e.g., an application server) or a computing system including a front-end component (e.g., a user computer with a graphical user interface or a web browser through which a user can interact with embodiments of the systems and techniques described herein), or a computing system including any combination of the back-end component, the middleware component, the front-end component. The components of the system can be interconnected by digital data communication (e.g., communication network) in any form or medium. Examples of communication networks include local area networks (LANs), wide area networks (WANs), and the Internet.

A computer system may include a client and a server. The client and the server are generally far away from each other and usually interact through communication networks. The relationship between the client and the server is generated by computer programs running on the corresponding computers and having a client server relationship with each other. The server can be a cloud server, a distributed system server, or a blockchain server.

It should be understood that various forms of processes shown above can be used to reorder, add or delete steps. For example, the steps recorded in the present disclosure can be performed in parallel, in sequence, or in different orders, as long as the desired results of the technical solution of the present disclosure can be achieved, which is not limited herein.

The above specific embodiments do not constitute restrictions on the scope of the present disclosure. Those skilled in the art should understand that various modifications, combinations, sub combinations and substitutions can be made according to design requirements and other factors. Any modification, equivalent replacement and improvement made within the spirit and principles of this disclosure shall be included in the scope of protection of this disclosure.

What is claimed is:

1. A method for generating a road annotation, comprising:
generating a road quantity and a road width in a tag picture;
generating, for each road in the tag picture, a start point and an end point of the road;
generating at least one point between the start point and the end point;
drawing, for two adjacent points, a line segment from a previous point to a next point, wherein a width of the line segment is equal to the road width; and
generating slanted box annotation information based on a coordinate of the previous point and a coordinate of the next point, wherein the slanted box annotation information comprises an intersection point of diagonal lines, a width, a height and a slant angle of a slanted box.

2. The method according to claim 1, wherein the generating at least one point between the start point and the end point comprises:
performing following point generation steps (1)-(3):
step (1) including generating a next point of the start point and determining whether a coordinate of the next point satisfies a preset condition;
step (2) including determining that a point generation is completed in response to the coordinate satisfying the preset condition; and
step (3) including using the next point as the start point and continuing to perform the point generation steps (1)-(3), in response to the coordinate not satisfying the preset condition.

3. The method according to claim 2, wherein a random number between an abscissa of the start point and an abscissa of the end point is taken as an abscissa of the next point, a random number between an ordinate of the start point and an ordinate of the end point is taken as an ordinate of the next point, and the preset condition comprises the abscissa of the next point being identical to an abscissa of the end point and/or the ordinate of the next point being identical to an ordinate of the end point.

4. The method according to claim 1, wherein the coordinate of the previous point is (x1, y1), the coordinate of the next point is (x2, y2), the road width is width, an abscissa cx of the intersection point of the diagonal lines of the slanted box satisfies cx=(x1+x2)/2, an ordinate cy of the intersection point of the diagonal lines of the slanted box satisfies cy=(y1+y2)/2, the width w of the slanted box satisfies w=\sqrt{(x2−x1)²+(y2−y1)²}, the height h of the slanted box satisfies h=width, and the slant angle theta of the slanted box satisfies theta=arctan 2[(y2−y1),(x2−x1)], wherein when
$$theta > \frac{3}{4} π ,$$
the slant angle theta of the slanted box satisfies theta=theta−π, and when
$$theta < - \frac{1}{4} π ,$$
the slant angle theta of the slanted box satisfies theta=theta+π.

5. The method according to claim 1, wherein generating the start point and the end point of the road comprises:
generating randomly a coordinate of the start point of the road;
generating randomly an indicator of a boundary where the end point of the road is, wherein the end point is on a boundary of the tag picture;
determining a value of the end point on one coordinate axis based on the indicator of the boundary where the end point is;
generating randomly a value of the end point on another coordinate axis; and
generating a coordinate of the end point based on the value of the end point on the one coordinate axis and the value of the end point on the another coordinate axis.

6. The method according to claim 1, wherein the generating a road quantity and a road width in a tag picture comprises:
generating the road quantity and the road width by generating a random number.

7. An electronic device, comprising:
at least one processor; and
a storage device, in communication with the at least one processor,
wherein the storage device stores instructions executable by the at least one processor, and the instructions are executed by the at least one processor, to enable the at least one processor to perform operations comprising:
generating a road quantity and a road width in a tag picture;
generating, for each road in the tag picture, a start point and an end point of the road;
generating at least one point between the start point and the end point;
drawing, for two adjacent points, a line segment from a previous point to a next point, wherein a width of the line segment is equal to the road width; and
generating slanted box annotation information based on a coordinate of the previous point and a coordinate of the next point, wherein the slanted box annotation information comprises an intersection point of diagonal lines, a width, a height and a slant angle of a slanted box.

8. The device according to claim 7, wherein the generating at least one point between the start point and the end point comprises:
performing following point generation steps (1)-(3):
step (1) including generating a next point of the start point and determining whether a coordinate of the next point satisfies a preset condition;
step (2) including determining that a point generation is completed in response to the coordinate satisfying the preset condition; and
step (3) including using the next point as the start point and continuing to perform the point generation steps (1)-(3), in response to the coordinate not satisfying the preset condition.

9. The device according to claim 8, wherein a random number between an abscissa of the start point and an abscissa of the end point is taken as an abscissa of the next point, a random number between an ordinate of the start point and an ordinate of the end point is taken as an ordinate of the next point, and the preset condition comprises the abscissa of the next point being identical to an abscissa of the end point and/or the ordinate of the next point being identical to an ordinate of the end point.

10. The device according to claim 7, wherein the coordinate of the previous point is (x1, y1), the coordinate of the next point is (x2, y2), the road width is width, an abscissa cx of the intersection point of the diagonal lines of the slanted box satisfies cx=(x1+x2)/2, an ordinate cy of the intersection point of the diagonal lines of the slanted box satisfies cy=(y1+y2)/2, the width w of the slanted box satisfies w=\sqrt{(x2−x1)²+(y2−y1)²}, the height h of the slanted box satisfies h=width, and the slant angle theta of the slanted box satisfies theta=arctan 2[(y2−y1),(x2−x1)], wherein when
$$theta > \frac{3}{4} π ,$$
the slant angle theta of the slanted box satisfies theta=theta−π, and when
$$theta < - \frac{1}{4} π ,$$
the slant angle theta of the slanted box satisfies theta=theta+π.

11. The device according to claim 7, wherein generating the start point and the end point of the road comprises:
generating randomly a coordinate of the start point of the road;
generating randomly an indicator of a boundary where the end point of the road is, wherein the end point is on a boundary of the tag picture;
determining a value of the end point on one coordinate axis based on the indicator of the boundary where the end point is;
generating randomly a value of the end point on another coordinate axis; and
generating a coordinate of the end point based on the value of the end point on the one coordinate axis and the value of the end point on the another coordinate axis.

12. The device according to claim 7, wherein the generating a road quantity and a road width in a tag picture comprises:
generating the road quantity and the road width by generating a random number.

13. A non-transitory computer readable storage medium, storing a computer instruction, wherein the computer instruction is used to cause a computer to perform operations comprising:
generating a road quantity and a road width in a tag picture;
generating, for each road in the tag picture, a start point and an end point of the road;
generating at least one point between the start point and the end point;
drawing, for two adjacent points, a line segment from a previous point to a next point, wherein a width of the line segment is equal to the road width; and
generating slanted box annotation information based on a coordinate of the previous point and a coordinate of the next point, wherein the slanted box annotation information comprises an intersection point of diagonal lines, a width, a height and a slant angle of a slanted box.

14. The storage medium according to claim 13, wherein the generating at least one point between the start point and the end point comprises:
performing following point generation steps (1)-(3):
step (1) including generating a next point of the start point and determining whether a coordinate of the next point satisfies a preset condition;
step (2) including determining that a point generation is completed in response to the coordinate satisfying the preset condition; and
step (3) including using the next point as the start point and continuing to perform the point generation steps (1)-(3), in response to the coordinate not satisfying the preset condition.

15. The storage medium according to claim 14, wherein a random number between an abscissa of the start point and an abscissa of the end point is taken as an abscissa of the next point, a random number between an ordinate of the start point and an ordinate of the end point is taken as an ordinate of the next point, and the preset condition comprises the abscissa of the next point being identical to an abscissa of the end point and/or the ordinate of the next point being identical to an ordinate of the end point.

16. The storage medium according to claim 13, wherein the coordinate of the previous point is (x1, y1), the coordinate of the next point is (x2, y2), the road width is width, an abscissa cx of the intersection point of the diagonal lines of the slanted box satisfies cx=(x1+x2)/2, an ordinate cy of the intersection point of the diagonal lines of the slanted box satisfies cy=(y1+y2)/2, the width w of the slanted box satisfies w=\sqrt{(x2−x1)²+(y2−y1)²}, the height h of the slanted box satisfies h=width, and the slant angle theta of the slanted box satisfies theta=arctan 2[(y2−y1),(x2−x1)], wherein when
$$theta > \frac{3}{4} π ,$$
the slant angle theta of the slanted box satisfies theta=theta−π, and when
$$theta < - \frac{1}{4} π ,$$
the slant angle theta of the slanted box satisfies theta=theta+π.

17. The storage medium according to claim 13, wherein generating the start point and the end point of the road comprises:
generating randomly a coordinate of the start point of the road;
generating randomly an indicator of a boundary where the end point of the road is, wherein the end point is on a boundary of the tag picture;
determining a value of the end point on one coordinate axis based on the indicator of the boundary where the end point is;
generating randomly a value of the end point on another coordinate axis; and
generating a coordinate of the end point based on the value of the end point on the one coordinate axis and the value of the end point on the another coordinate axis.

18. The storage medium according to claim 13, wherein the generating a road quantity and a road width in a tag picture comprises:
generating the road quantity and the road width by generating a random number.
